(19) United States
(12) Patent Application Publication
(10) Pub. No.: US 2012/0003383 A1
(43) Pub. Date: Jan. 5, 2012

(54) MANUFACTURING METHOD OF ENERGY STORAGE DEVICE

(75) Inventor: Makoto FURUNO, Atsugi (JP)

(73) Assignee: SEMICONDUCTOR ENERGY LABORATORY CO., LTD., Atsugi-shi (JP)

(21) Appl. No.: 13/158,619

(22) Filed: Jun. 13, 2011

(30) Foreign Application Priority Data
Jun. 30, 2010 (JP) 2010-149164
Jun. 30, 2010 (JP) 2010-149175

(51) Int. Cl. B05D 5/12

(52) U.S. Cl. 427/123; 427/58

(57) ABSTRACT

A manufacturing method of an energy storage device capable of increasing the discharge capacity or an energy storage device capable of suppression of degradation of an electrode due to repetitive charge and discharge is provided. In the manufacturing method, a crystalline silicon layer including a group of whiskers in which the whiskers are tightly formed is formed as an active material layer over a current collector by a low pressure chemical vapor deposition method using a gas containing silicon as a source gas and nitrogen or helium as a dilution gas.

### BACKGROUND OF THE INVENTION

1. Field of the Invention

The technical field of the present invention relates to an energy storage device and a manufacturing method thereof.

Note that the energy storage device refers to all elements and devices which have a function of storing energy.

2. Description of the Related Art

In recent years, energy storage devices such as lithium ion secondary batteries, lithium ion capacitors, and air cells have been developed.

An electrode for an energy storage device is formed by providing an active material on a surface of a current collector. As the active material, for example, a material (e.g., carbon or silicon) which can absorb and release ions serving as carriers is used. In particular, silicon or phosphorus-doped silicon has a higher theoretical capacity than carbon, and thus is advantageous in increasing the capacity of the energy storage device (e.g., Patent Document 1).

[Reference]

[Patent Document 1] Japanese Published Patent Application No. 2001-210315

### SUMMARY OF THE INVENTION

However, even when silicon is used as an active material such as a negative electrode active material, it is difficult to obtain a discharge capacity as high as the theoretical capacity.

In view of the above, an object of one embodiment of the present invention is to provide an energy storage device with a structure capable of improving the performance by an increase in discharge capacity, or the like, and a manufacturing method of the energy storage device.

Another object of one embodiment of the present invention is to provide an energy storage device with a structure capable of improving the performance by suppression of deterioration of an electrode due to repetitive charge and discharge, or the like, and a manufacturing method of the energy storage device.

One embodiment of the present invention is a manufacturing method of an energy storage device, in which a crystalline silicon layer including a group of whiskers is formed as an active material layer over a current collector by a low pressure chemical vapor deposition (LPCVD) method using nitrogen and a gas containing silicon.

In the above embodiment, it is preferable that the flow rate of the gas containing silicon be greater than or equal to 100 sccm and less than or equal to 3000 sccm and that the flow rate of nitrogen be greater than or equal to 100 sccm and less than or equal to 1000 sccm.

In the above embodiment, a plurality of whisker-like protrusions (hereinafter, also referred to as whiskers) is provided on a surface side of the crystalline silicon layer. Moreover, the plurality of whiskers is densely formed so that a group of whiskers is formed.

One embodiment of the present invention is a manufacturing method of an energy storage device, in which a crystalline silicon layer including a group of whiskers is formed as an active material layer over a current collector by an LPCVD method using helium and a gas containing silicon.

In the above embodiment, it is preferable that the flow rate of the gas containing silicon be greater than or equal to 100 sccm and less than or equal to 3000 sccm and that the flow rate of helium be greater than or equal to 100 sccm and less than or equal to 1000 sccm.

In the above embodiment, a plurality of protrusions including whisker-like protrusions (also referred to as whiskers) is provided on a surface side of the crystalline silicon layer. Moreover, the plurality of whiskers is densely formed so that a group of whiskers is formed.

In the above embodiment, it is preferable that the gas containing silicon include silicon hydride, silicon fluoride, or silicon chloride.

In the above embodiment, it is preferable that the heating temperature in the LPCVD method be higher than or equal to 595° C. and lower than 650° C.

In the above embodiment, it is preferable that the pressure in the LPCVD method be greater than or equal to 10 Pa and less than or equal to 100 Pa.

According to one embodiment of the present invention, an energy storage device with a high discharge capacity can be provided. According to one embodiment of the present invention, a manufacturing method of an energy storage device with a high discharge capacity can be provided.

According to one embodiment of the present invention, an energy storage device in which deterioration of an electrode due to repetitive charge and discharge is suppressed can be provided. According to one embodiment of the present invention, a manufacturing method of an energy storage device in which deterioration of an electrode due to repetitive charge and discharge is suppressed can be provided.

According to one embodiment of the present invention, a high-performance energy storage device can be provided. According to one embodiment of the present invention, a manufacturing method of a high-performance energy storage device can be provided.

### BRIEF DESCRIPTION OF THE DRAWINGS

FIGS. 1A and 1B are cross-sectional views illustrating a structure and a manufacturing method of an electrode of an energy storage device.

FIG. 2 is a cross-sectional view illustrating a structure and a manufacturing method of an electrode of an energy storage device.

FIGS. 3A and 3B are a plan view and a cross-sectional view illustrating a structure of an energy storage device.

FIGS. 4A and 4B are perspective views illustrating an application example of an energy storage device.

FIG. 5 is a perspective view illustrating an application example of an energy storage device.

FIG. 6 is a block diagram showing a structure of an RF power feeding system.

FIG. 7 is a block diagram showing a structure of an RF power feeding system.

FIGS. 8A and 8B are SEM images of a crystalline silicon layer.

FIGS. 9A and 9B are SEM images of a crystalline silicon layer.

FIG. 10 is a cross-sectional view illustrating a structure and a manufacturing method of an electrode of an energy storage device.

FIGS. 11A and 11B are cross-sectional views illustrating a structure and a manufacturing method of an electrode of an energy storage device.

FIG. 12 is a cross-sectional view illustrating a structure and a manufacturing method of an electrode of an energy storage device.

FIGS. 13A and 13B are SEM images of a crystalline silicon layer.

FIGS. 14A and 14B are SEM images of a crystalline silicon layer.

### DETAILED DESCRIPTION OF THE INVENTION

Hereinafter, Embodiments and Examples of the present invention will be described with reference to the drawings. Note that the present invention is not limited to the following description, and it will be easily understood by those skilled in the art that various changes and modifications can be made without departing from the spirit and scope of the invention. Thus, the present invention should not be construed as being limited to the description of the embodiments to be given below. Note that in the drawings which are referred to, like reference numerals designate like portions in different drawings in some cases. Further, in some cases, the same hatching patterns are applied to similar parts and the reference numerals thereof may be omitted.

### EMBODIMENT 1

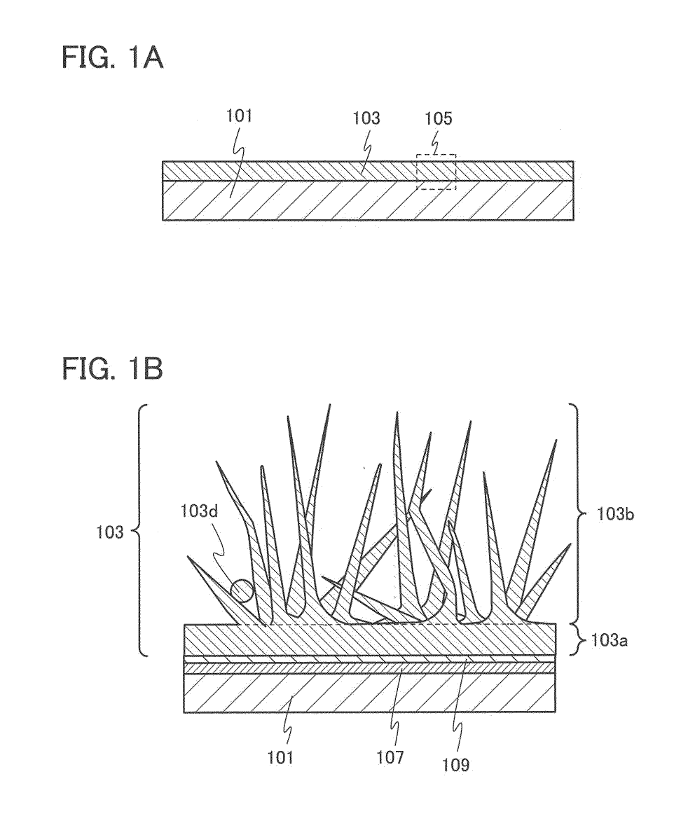

In this embodiment, a structure and a manufacturing method of an electrode of an energy storage device will be described with reference to FIGS. 1A and 1B, FIG. 2, and FIG. 10.

First, a current collector 101 is prepared (see FIG. 1A). The current collector 101 functions as a current collector of the electrode.

A conductive material having a foil shape, a plate shape, or a net shape can be used as the current collector 101. The current collector 101 can be formed using, without particular limitation, a metal element with high conductivity typified by platinum, aluminum, copper, or titanium. Note that the current collector 101 may be formed using an aluminum alloy to which an element which improves heat resistance, such as silicon, titanium, neodymium, scandium, or molybdenum, is added.

Alternatively, the current collector 101 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, nickel, and the like.

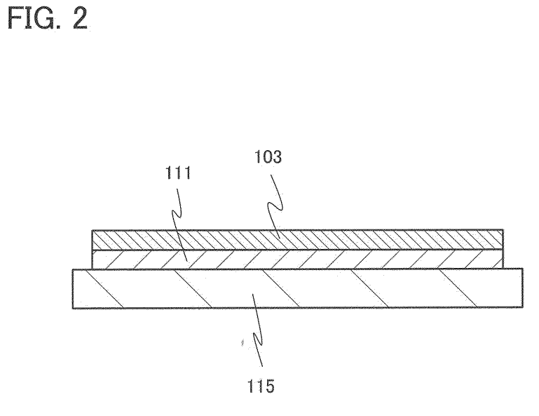

As in FIG. 2, a current collector 111 which is formed over a substrate 115 by a sputtering method, an evaporation method, a printing method, an ink-jet method, a chemical vapor deposition (CVD) method, or the like may be used as a current collector of the electrode. As the substrate 115, for example, a glass substrate can be used.

Next, a crystalline silicon layer is formed as an active material layer 103 over the current collector 101 by a thermal CVD method, preferably an LPCVD method (see FIG. 1A). The electrode of the energy storage device includes the current collector 101 and the crystalline silicon layer which functions as the active material layer 103.

In this embodiment, the case where a crystalline silicon layer is formed as the active material layer 103 by an LPCVD method will be described. Note that, although an example in which the active material layer 103 is formed on one surface of the current collector 101 is illustrated in FIG. 1A, the crystalline silicon layers as the active material layer may be formed on both surfaces of the current collector.

In the formation of the crystalline silicon layer by an LPCVD method, a gas containing silicon used as a source gas and nitrogen used as a dilution gas are mixed. Examples of the gas containing silicon include silicon hydride, silicon fluoride, and silicon chloride; typically, silane (SiH₄), disilane (Si₂H₆), silicon tetrafluoride (SiF₄), silicon tetrachloride (SiCl₄), disilicon hexachloride (Si₂Cl₆), or the like can be used.

Note that an impurity element imparting one conductivity type, such as phosphorus or boron, may be added to the crystalline silicon layer. When an impurity element imparting one conductivity type, such as phosphorus or boron, is added to a crystalline silicon layer, the crystalline silicon layer has higher conductivity, which allows the electrical conductivity of the electrode to be increased. Accordingly, the discharge capacity or charge capacity of the energy storage device can be increased.

In the formation of the crystalline silicon layer by an LPCVD method, the heating temperature is set higher than 550° C. and lower than or equal to the temperature that an LPCVD apparatus and the current collector 101 can withstand, preferably higher than or equal to 595° C. and lower than 650° C.

The flow rate of the gas containing silicon is set greater than or equal to 100 sccm and less than or equal to 3000 sccm, and the flow rate of nitrogen is set greater than or equal to 100 sccm and less than or equal to 1000 sccm.

Moreover, the crystalline silicon layer is formed by an LPCVD method under pressure greater than or equal to 10 Pa and less than or equal to 100 Pa.

Note that when the crystalline silicon layer formed by an LPCVD method is used as the active material layer 103, electrons can easily move at an interface between the current collector 101 and the active material layer 103 and the adhesion can be increased. The reason for the above is as follows: in a deposition step of the crystalline silicon layer, active species of the source gas are constantly supplied to the crystalline silicon layer during deposition, which prevents formation of a low-density region in the crystalline silicon layer. In addition, since the crystalline silicon layer is formed over the current collector 101 by vapor deposition, the productivity of the energy storage device can be increased.

The use of an LPCVD method makes it possible to form the crystalline silicon layers on a top surface and a bottom surface of the current collector 101 in one deposition step. Thus, the number of steps can be reduced in the case where the electrode of the energy storage device is formed using the current collector 101 and the crystalline silicon layers as the active material layer formed on the both surfaces of the current collector 101. For example, an LPCVD method is effective in manufacturing a stack-type energy storage device.

FIG. 1B is an enlarged view of the current collector 101 and the active material layer 103 in a region 105 surrounded by a dashed line in FIG. 1A.

The crystalline silicon layer is formed by an LPCVD method by mixing nitrogen with the gas containing silicon, whereby a group of whiskers can be formed in the active material layer 103 as illustrated in FIG. 1B.

The active material layer 103 includes a crystalline silicon region 103a and a crystalline silicon region 103b including the group of whiskers formed on the crystalline silicon region 103a.

Note that the boundary between the crystalline silicon region 103a and the crystalline silicon region 103b is not clear. Therefore, in this embodiment, the plane that is at the same level as the bottom of the deepest valley of the valleys formed among a plurality of protrusions in the crystalline silicon region 103b and is parallel to the surface of the current collector 101 is regarded as the boundary between the crystalline silicon region 103a and the crystalline silicon region 103b.

The crystalline silicon region 103a is formed so as to cover the current collector 101.

In the crystalline silicon region 103b, a plurality of whisker-like protrusions (also referred to as whiskers) is densely formed so that a group of whiskers is formed.

The majority of the plurality of whiskers included in the group of whiskers are sharp needle-like protrusions (including conical protrusions or pyramidal protrusions).

When the majority of the plurality of whiskers included in the group of whiskers are needle-like protrusions, the surface area per unit mass of the active material layer 103 can be increased.

With the needle-like protrusions having a large surface area, the rate at which a reaction substance (e.g., lithium ions) in the energy storage device is absorbed to or released from crystalline silicon is increased per unit mass. When the rate at which the reaction substance is absorbed or released is increased, the amount of absorption or release of the reaction substance at a high current density is increased; thus, the discharge capacity or charge capacity of the energy storage device can be increased.

As described above, the active material layer includes the crystalline silicon layer including the group of whiskers and a large number of needle-like protrusions are included in the group of whiskers, whereby the performance of the energy storage device can be improved.

In the group of whiskers including the plurality of densely formed whiskers, the plurality of whiskers is tightly formed (i.e., the number of whiskers included in the group of whiskers is large) and the needle-like protrusions which are the majority of the group of whiskers are long and thin, which allows the protrusions to tangle. This can prevent the protrusions from being detached when the energy storage device is charged and discharged. Accordingly, degradation of the electrode due to repetitive charge and discharge can be reduced and the energy storage device can be used for a long time.

Further, in the group of whiskers including the plurality of densely formed whiskers, the plurality of whiskers is tightly formed; thus, the whiskers are unlikely to be broken even when the whiskers are long and thin. Thus, the strength of the active material layer in the thickness direction is increased. The increase in the strength of the active material layer can reduce degradation of the electrode due to repetitive charge and discharge, vibration, or the like. Accordingly, the durability or the like of the energy storage device can be improved.

Note that the plurality of protrusions may include columnar protrusions (including cylindrical protrusions or prismatic protrusions). The plurality of protrusions may also include a protrusion having a branching portion and a protrusion having a bending portion.

The diameter of the needle-like protrusion is less than or equal to 5 μm. The length along the axis of the needle-like protrusion is greater than or equal to 5 μm and less than or equal to 30 μm. Note that the length along the axis of the needle-like protrusion corresponds to the distance between the top of the protrusion and the crystalline silicon region 103a along the axis running through the top of the protrusion.

The thickness of the whisker-like crystalline silicon region 103b is greater than or equal to 5 μm and less than or equal to 20 μm. Note that the thickness of the crystalline silicon region 103b corresponds to the length of the line which perpendicularly runs from the top of the protrusion to the surface of the crystalline silicon region 103a.

The longitudinal directions of the plurality of protrusions included in the group of whiskers vary in FIG. 1B. Therefore, in FIG. 1B, a circular region 103d is illustrated in order to show the state where a transverse cross-sectional shape of the protrusion exists as well as longitudinal cross-sectional shapes of the protrusions. Here, the longitudinal direction means the direction in which the needle-like protrusion extends from the crystalline silicon region 103a, and the longitudinal cross-sectional shape means the cross-sectional shape along the longitudinal direction. In addition, the transverse cross-sectional shape means the cross-sectional shape along the direction perpendicular to the longitudinal direction.

When the longitudinal directions of the plurality of protrusions vary as in FIG. 1B, the protrusions easily tangle, which makes it possible to prevent the protrusions from being detached at the time when the energy storage device is charged and discharged and to stabilize the charge and discharge characteristics.

Note that as illustrated in FIG. 1B, a layer 107 (also referred to as a material layer) may be formed between the current collector 101 and the active material layer 103.

When the layer 107 is provided, the resistance of the interface between the current collector 101 and the active material layer 103 can be reduced; thus, the discharge capacity or charge capacity of the energy storage device can be increased. In addition, the layer 107 allows the adhesion between the current collector 101 and the active material layer 103 to be increased; thus, degradation of the energy storage device can be reduced.

The layer 107 may be, for example, a mixed layer of a metal element contained in the current collector 101 and silicon contained in the active material layer 103. In that case, the layer 107 can be formed in such a manner that silicon contained in the crystalline silicon layer is dispersed into the current collector 101 by heating performed when the crystalline silicon layer is formed as the active material layer 103 by an LPCVD method.

Alternatively, the layer 107 may be a compound layer (a layer including silicide) of a metal element contained in the current collector 101 and silicon contained in the active material layer 103. In that case, the metal element contained in the current collector 101 is a metal element which forms silicide by reacting with silicon. Examples of the silicide include zirconium silicide, titanium silicide, hafnium silicide, vanadium silicide, niobium silicide, tantalum silicide, chromium silicide, molybdenum silicide, tungsten silicide, cobalt silicide, and nickel silicide.

Note that as illustrated in FIG. 1B, a metal oxide layer 109 may be formed between the current collector 101 and the active material layer 103. The metal oxide layer 109 is a layer of an oxide of the metal element contained in the current collector 101. Note that in the case where the layer 107 is provided, the metal oxide layer 109 is provided over the layer 107.

When the metal oxide layer 109 is provided, the resistance between the current collector 101 and the active material layer 103 can be reduced; thus, the electrical conductivity of the electrode can be increased. As a result, the rate at which a reaction substance is absorbed or released can be increased; thus, the discharge capacity or charge capacity of the energy storage device can be increased.

The metal oxide layer 109 is formed in such a manner that oxygen is released from a quartz chamber of the LPCVD apparatus and the current collector 101 is oxidized. Note that when the chamber is filled with a rare gas such as helium, neon, argon, or xenon in the formation of the crystalline silicon layer by an LPCVD method, the metal oxide layer 109 is not formed.

In the case where the current collector 101 is formed using, for example, titanium, zirconium, niobium, tungsten, or the like, the metal oxide layer 109 is formed using an oxide semiconductor such as titanium oxide, zirconium oxide, niobium oxide, or tungsten oxide.

Note that when the crystalline silicon layer is used as the active material layer 103, an oxide film such as a natural oxide film with low conductivity is formed on the surface of the crystalline silicon layer in some cases. In addition, when the oxide film such as a natural oxide film is overloaded at the time of charge and discharge, the function of the electrode might be impaired and improvement of the cycle characteristics of the energy storage device might be hindered.

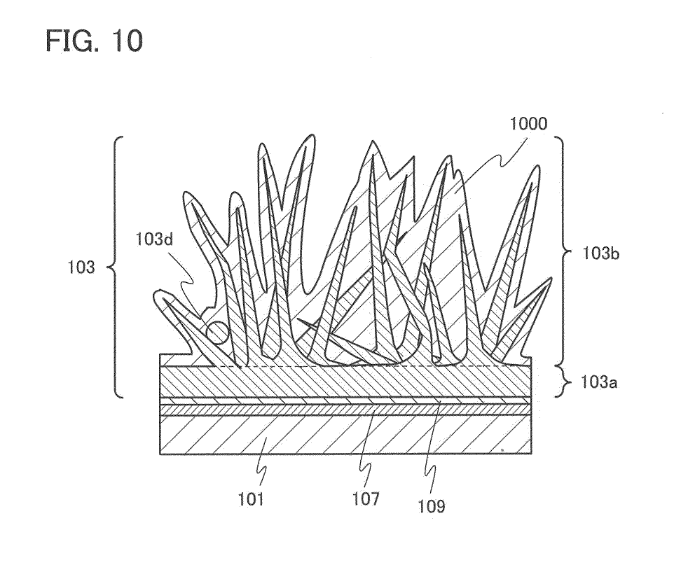

In that case, the oxide film such as a natural oxide film which is formed on the surface of the active material layer 103 may be removed, and a conductive layer 1000 may be formed on the active material layer 103 the surface of which is not provided with the oxide film such as a natural oxide film (see FIG. 10).

The oxide film such as a natural oxide film can be removed by wet etching treatment using, as an etchant, a solution containing hydrofluoric acid or an aqueous solution containing hydrofluoric acid. Alternatively, dry etching treatment may be employed as long as the dry etching treatment is capable of removing the oxide film such as a natural oxide film. Alternatively, wet etching treatment and dry etching treatment may be employed in combination. For the dry etching treatment, a parallel plate reactive ion etching (RIE) method, an inductively coupled plasma (ICP) etching method, or the like can be used.

A layer having higher conductivity than the oxide film such as a natural oxide film is used as the conductive layer 1000. Accordingly, the conductivity of the electrode surface of the energy storage device is improved as compared to the case where the surface of the active material layer 103 is covered with an oxide film such as a natural oxide film. This can prevent an oxide film such as a natural oxide film from being overloaded at the time of charge and discharge and the function of the electrode from being impaired; thus, the cycle characteristics of the energy storage device can be improved.

The conductive layer 1000 can be formed using a metal element with high conductivity typified by copper, nickel, titanium, manganese, cobalt, or iron. In particular, it is preferable to use copper r nickel. The conductive layer 1000 may contain at least one of the metal elements or may be formed as a metal layer or a compound layer, or silicide may be formed by reaction between the metal element and silicon of the active material layer 103. For example, a compound such as iron phosphate may be used for the conductive layer 1000.

Note that it is preferable to use an element with low reactivity to lithium, such as copper or nickel, for the conductive layer 1000. When the active material layer 103 is covered with the conductive layer 1000 formed using copper, nickel, or the like silicon, which is separated due to change in volume as a result of absorption and release of lithium ions, can be kept in the active material layer 103. Accordingly, the active material layer 103 can be prevented from being broken even when charge and discharge are repeated. Thus, the cycle characteristics of the energy storage device can be improved.

The conductive layer 1000 can be formed by a CVD method or a sputtering method. In particular, a metal organic chemical vapor deposition (MOCVD) method is preferably employed.

Through the above process, the electrode of the energy storage device can be manufactured.

This embodiment can be implemented in combination with any of the other embodiments or the examples as appropriate.

### EMBODIMENT 2

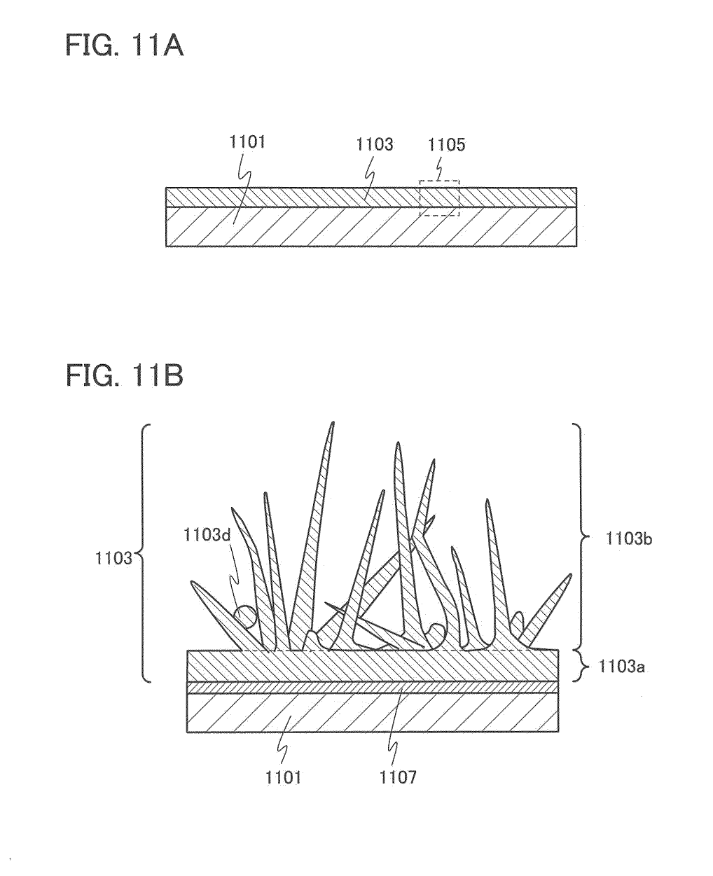

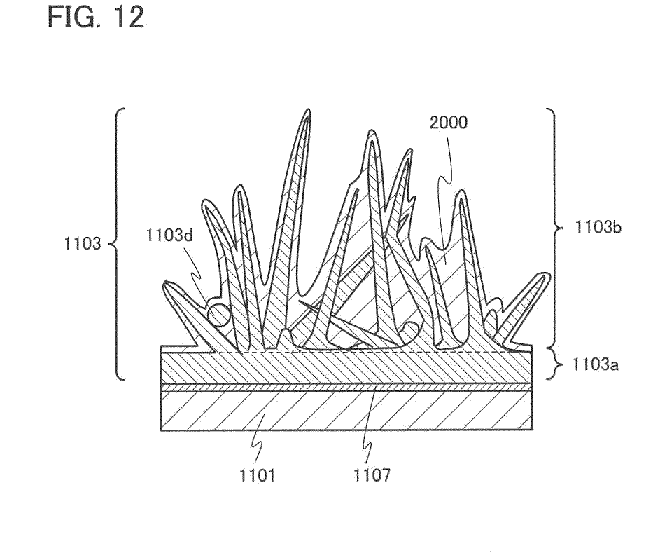

In this embodiment, a structure and a manufacturing method of an electrode of an energy storage device will be described with reference to FIGS. 11A and 11B and FIG. 12.

First, a current collector 1101 is prepared (see FIG. 11A). The current collector 1101 functions as a current collector of the electrode.

A material similar to that of the current collector 101 described in Embodiment 1 can be used for the current collector 1101.

Alternatively, in a manner similar to that in Embodiment 1 described with reference to FIG. 2, a current collector which is formed over a substrate by a sputtering method, an evaporation method, a printing method, an ink-jet method, a CVD method, or the like may be used as a current collector of the electrode. For example, a glass substrate can be used as the substrate.

Next, a crystalline silicon layer is formed as an active material layer 1103 over the current collector 1101 by a thermal CVD method, preferably an LPCVD method (see FIG. 11A). The electrode of the energy storage device includes the current collector 1101 and the crystalline silicon layer which functions as the active material layer 1103.

In this embodiment, the case where a crystalline silicon layer is formed as the active material layer 1103 by an LPCVD method will be described. Note that, although an example in which the active material layer 1103 is formed on one surface of the current collector 1101 is illustrated in FIG. 11A, the crystalline silicon layers as the active material layer may be formed on both surfaces of the current collector.

In the formation of the crystalline silicon layer by an LPCVD method, a gas containing silicon used as a source gas and helium used as a dilution gas are mixed. As the gas containing silicon, any of the source gases given in Embodiment 1 can be used. Note that as the dilution gas, a rare gas other than helium (e.g., argon) may be used.

Note that an impurity element imparting one conductivity type, such as phosphorus or boron, may be added to the crystalline silicon layer. When an impurity element imparting one conductivity type, such as phosphorus or boron, is added to a crystalline silicon layer, the crystalline silicon layer has higher conductivity, which allows the electrical conductivity of the electrode to be increased. Accordingly, the discharge capacity or charge capacity of the energy storage device can be increased.

In the formation of the crystalline silicon layer by an LPCVD method, the heating temperature is set higher than 550° C. and lower than or equal to the temperature that an LPCVD apparatus and the current collector 1101 can withstand, preferably higher than or equal to 595° C. and lower than 650° C.

The flow rate of the gas containing silicon is set greater than or equal to 100 sccm and less than or equal to 3000 sccm, and the flow rate of helium is set greater than or equal to 100 sccm and less than or equal to 1000 sccm.

Moreover, the crystalline silicon layer is formed by an LPCVD method under pressure greater than or equal to 10 Pa and less than or equal to 100 Pa.

Note that when the crystalline silicon layer formed by an LPCVD method is used as the active material layer 1103, electrons can easily move at an interface between the current collector 1101 and the active material layer 1103 and the adhesion can be increased. The reason for the above is as follows: in a deposition step of the crystalline silicon layer, active species of the source gas are constantly supplied to the crystalline silicon layer during deposition, which prevents formation of a low-density region in the crystalline silicon layer. In addition, since the crystalline silicon layer is formed over the current collector 1101 by vapor deposition, the productivity of the energy storage device can be increased.

The use of an LPCVD method makes it possible to form the crystalline silicon layers on a top surface and a bottom surface of the current collector 1101 in one deposition step. Thus, the number of steps can be reduced in the case where the electrode of the energy storage device is formed using the current collector 1101 and the crystalline silicon layers as the active material layer formed on the both surfaces of the current collector 1101. For example, an LPCVD method is effective in manufacturing a stack-type energy storage device.

FIG. 11B is an enlarged view of the current collector 1101 and the active material layer 1103 in a region 1105 surrounded by a dashed line in FIG. 11A.

The crystalline silicon layer is formed by an LPCVD method by mixing helium with the gas containing silicon, whereby a group of whiskers can be formed in the active material layer 1103 as illustrated in FIG. 11B.

The active material layer 1103 includes a crystalline silicon region 1103a and a crystalline silicon region 1103b including the group of whiskers formed on the crystalline silicon region 1103a.

Note that the boundary between the crystalline silicon region 1103a and the crystalline silicon region 1103b is not clear. Therefore, in this embodiment, the plane that is at the same level as the bottom of the deepest valley of the valleys formed among a plurality of protrusions in the crystalline silicon region 1103b and is parallel to the surface of the current collector 1101 is regarded as the boundary between the crystalline silicon region 1103a and the crystalline silicon region 1103b.

The crystalline silicon region 1103a is formed so as to cover the current collector 1101.

In the crystalline silicon region 1103b, a plurality of whisker-like protrusions (also referred to as whiskers) is densely formed so that a group of whiskers is formed.

The majority of the plurality of whiskers included in the group of whiskers are sharp needle-like protrusions (including conical protrusions or pyramidal protrusions). Note that the group of whiskers may include columnar protrusions (including cylindrical protrusions or prismatic protrusions) in addition to the needle-like protrusions.

When the majority of the plurality of whiskers included in the group of whiskers are needle-like protrusions, the surface area per unit mass of the active material layer 1103 can be increased.

With the needle-like protrusions having a large surface area, the rate at which a reaction substance (e.g., lithium ions) in the energy storage device is absorbed to or released from crystalline silicon is increased per unit mass. When the rate at which the reaction substance is absorbed or released is increased, the amount of absorption or release of the reaction substance at a high current density is increased; thus, the discharge capacity or charge capacity of the energy storage device can be increased.

As described above, the active material layer includes the crystalline silicon layer including the group of whiskers. In addition, a large number of needle-like protrusions are included in the group of whiskers, so that the performance of the energy storage device can be improved.

In the group of whiskers including the plurality of densely formed whiskers, the plurality of whiskers is tightly formed (i.e., the number of whiskers included in the group of whiskers is large) and the needle-like protrusions which are the majority of the group of whiskers are long and thin, which allows the protrusions to tangle. This can prevent the protrusions from being detached when the energy storage device is charged and discharged. Accordingly, degradation of the electrode due to repetitive charge and discharge can be reduced and the energy storage device can be used for a long time.

Further, in the group of whiskers including the plurality of densely formed whiskers, the plurality of whiskers is tightly formed; thus, the whiskers are unlikely to be broken even when the whiskers are long and thin. Thus, the strength of the active material layer in the thickness direction is increased. The increase in the strength of the active material layer can reduce degradation of the electrode due to repetitive charge and discharge, vibration, or the like. Accordingly, the durability or the like of the energy storage device can be improved.

Note that the plurality of protrusions may also include a protrusion having a branching portion and a protrusion having a bending portion.

The diameter of the needle-like protrusion is less than or equal to 5 μm. The length along the axis of the protrusion is greater than or equal to 5 μm and less than or equal to 30 μm. Note that the length along the axis of the needle-like protrusion corresponds to the distance between the top of the protrusion and the crystalline silicon region 1103a along the axis running through the top of the protrusion.

The thickness of the whisker-like crystalline silicon region 1103b is greater than or equal to 5 μm and less than or equal to 20 μm. Note that the thickness of the crystalline silicon region 1103b corresponds to the length of the line which perpendicularly runs from the top of the protrusion to the surface of the crystalline silicon region 1103a.

The longitudinal directions of the plurality of protrusions included in the group of whiskers vary in FIG. 11B. Therefore, in FIG. 11B, a circular region 1103d is illustrated in order to show the state where a transverse cross-sectional shape of the protrusion exists as well as longitudinal cross-sectional shapes of the protrusions. Here, the longitudinal direction means the direction in which the needle-like protrusion extends from the crystalline silicon region 1103a, and the longitudinal cross-sectional shape means the cross-sectional shape along the longitudinal direction. In addition, the transverse cross-sectional shape means the cross-sectional shape along the direction perpendicular to the longitudinal direction.

When the longitudinal directions of the plurality of protrusions vary as in FIG. 11B, the protrusions easily tangle, which makes it possible to prevent the protrusions from being detached at the time when the energy storage device is charged and discharged and to stabilize the charge and discharge characteristics.

Note that as illustrated in FIG. 11B, a layer 1107 (also referred to as a material layer) may be formed between the current collector 1101 and the active material layer 1103.

When the layer 1107 is provided, the resistance of the interface between the current collector 1101 and the active material layer 1103 can be reduced; thus, the discharge capacity or charge capacity of the energy storage device can be increased. In addition, the layer 1107 allows the adhesion between the current collector 1101 and the active material layer 1103 to be increased; thus, degradation of the energy storage device can be reduced.

A material similar to that of the layer 107 described in Embodiment 1 can be used for the layer 1107. In addition, the layer 1107 can be formed by a method similar to that of the layer 107 described in Embodiment 1.

Note that when the crystalline silicon layer is used as the active material layer 1103, an oxide film such as a natural oxide film with low conductivity is formed on the surface of the crystalline silicon layer in some cases. In addition, when the oxide film such as a natural oxide film is overloaded at the time of charge and discharge, the function of the electrode might be impaired and improvement of the cycle characteristics of the energy storage device might be hindered.

In that case, the oxide film such as a natural oxide film which is formed on the surface of the active material layer 1103 may be removed, and a conductive layer 2000 may be formed on the active material layer 1103 the surface of which is not provided with the oxide film such as a natural oxide film (see FIG. 12).

The oxide film such as a natural oxide film can be removed by wet etching treatment using, as an etchant, a solution containing hydrofluoric acid or an aqueous solution containing hydrofluoric acid. Alternatively, dry etching treatment may be employed as long as the dry etching treatment is capable of removing the oxide film such as a natural oxide film. Alternatively, wet etching treatment and dry etching treatment may be employed in combination. For the dry etching treatment, a parallel plate RIE method, an ICP etching method, or the like can be used.

A material similar to that of the conductive layer 1000 described in Embodiment 1 can be used for the conductive layer 2000. In addition, the conductive layer 2000 can be formed by a method similar to that of the conductive layer 1000 described in Embodiment 1.

Through the above process, the electrode of the energy storage device can be manufactured.

This embodiment can be implemented in combination with any of the other embodiments or the examples as appropriate.

### EMBODIMENT 3

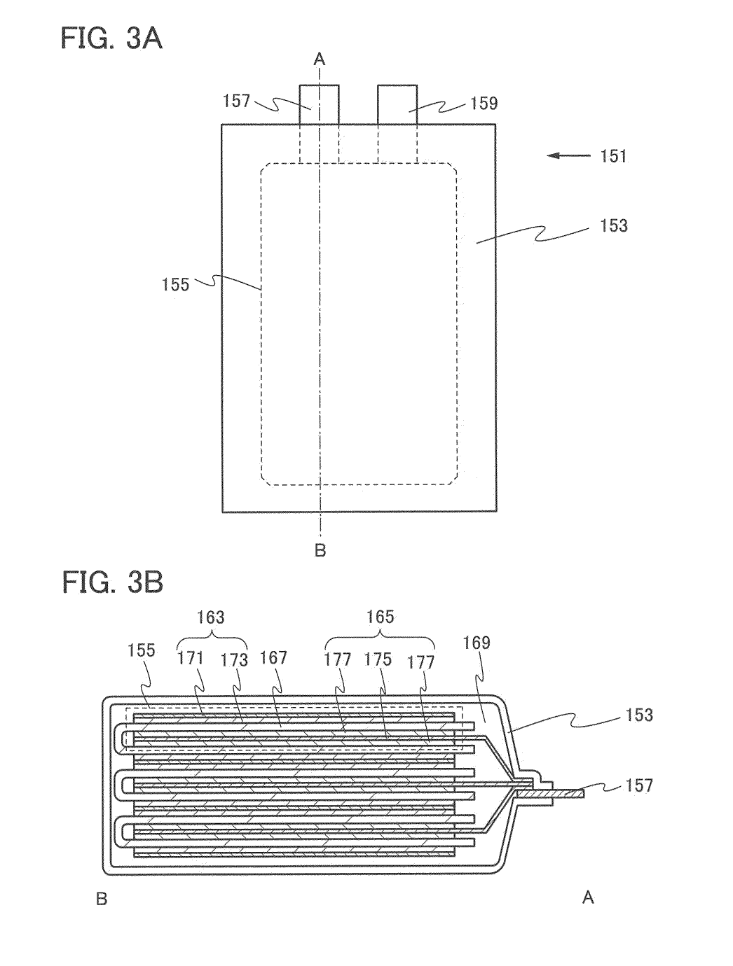

In this embodiment, a structure of an energy storage device will be described with reference to FIGS. 3A and 3B.

First, a structure of a secondary battery will be described below as an example of the energy storage device.

Among secondary batteries, a lithium ion battery formed using a metal oxide containing lithium, such as LiCoO₂, has a large discharge capacity and high safety. Here, the structure of a lithium ion battery, which is a typical example of the secondary battery, is described.

FIG. 3A is a plan view of an energy storage device 151, and FIG. 3B is a cross-sectional view taken along dot-dashed line A-B in FIG. 3A

The energy storage device 151 illustrated in FIG. 3A includes an energy storage cell 155 in an exterior member 153. The energy storage device further includes terminal portions 157 and 159 which are connected to the energy storage cell 155. For the exterior member 153, a laminate film, a polymer film, a metal film, a metal case, a plastic case, or the like can be used.

As illustrated in FIG. 3B, the energy storage cell 155 includes a negative electrode 163, a positive electrode 165, a separator 167 between the negative electrode 163 and the positive electrode 165, and an electrolyte 169 with which the exterior member 153 is filled.

The negative electrode 163 includes a negative electrode current collector 171 and a negative electrode active material layer 173. The electrode in Embodiment 1 or Embodiment 2 can be used as the negative electrode 163.

As the negative electrode active material layer 173, the active material layer 103 formed using the crystalline silicon layer which is described in Embodiment 1, or the active material layer 1103 formed using the crystalline silicon layer which is described in Embodiment 2 can be used.

Note that the crystalline silicon layer may be pre-doped with lithium. In addition, in the case where an electrode is formed using both surfaces of the negative electrode current collector 171 in an LPCVD apparatus, the negative electrode active material layer 173 which is formed using the crystalline silicon layer is formed while the negative electrode current collector 171 is held by a frame-like susceptor, whereby the negative electrode active material layers 173 can be formed on the both surfaces of the negative electrode current collector 171 at the same time and the number of steps can be reduced.

The positive electrode 165 includes a positive electrode current collector 175 and a positive electrode active material layer 177. The negative electrode active material layer 173 is formed on one or both surfaces of the negative electrode current collector 171. The positive electrode active material layer 177 is formed on one surface of the positive electrode current collector 175.

The negative electrode current collector 171 is connected to the terminal portion 159. The positive electrode current collector 175 is connected to the terminal portion 157. Further, the terminal portions 157 and 159 each partly extend outside the exterior member 153.

Note that, although a sealed thin energy storage device is described as the energy storage device 151 in this embodiment, an energy storage device can have a variety of shapes, for example, a button shape, a cylindrical shape, or a rectangular shape. Further, although the structure in which the positive electrode, the negative electrode, and the separator are stacked is described in this embodiment, a structure in which the positive electrode, the negative electrode, and the separator are rolled may be employed.

Aluminum, stainless steel, or the like is used for the positive electrode current collector 175. The positive electrode current collector 175 can have a foil shape, a plate shape, a net shape, or the like as appropriate.

The positive electrode active material layer 177 can be formed using LiFeO₂, LiCoO₂, LiNiO₂, LiMn₂O₄, LiFePO₄, LiCoPO₄, LiNiPO₄, LiMn₂PO₄, V₂O₅, Cr₂O₅, MnO₂, or any other lithium compounds as a material. Note that in the case where carrier ions are alkali metal ions other than lithium ions, alkaline earth metal ions, or the like, the positive electrode active material layer 177 can be formed using an alkali metal (e.g., sodium or potassium), an alkaline earth metal (e.g., calcium, strontium, or barium), beryllium, or magnesium instead of lithium in the above lithium compounds.

As a solute of the electrolyte 169, a material in which lithium ions, which are carrier ions, can move and stably exist is used. Typical examples of the solute of the electrolyte 169 include lithium salt such as LiClO₄, LiAsF₆, LiBF₄, LiPF₆, and Li(C₂F₅SO₂)₂N. Note that when carrier ions are alkali metal ions other than lithium or alkaline earth metal ions, alkali metal salt such as sodium salt or potassium salt, alkaline earth metal salt such as calcium salt, strontium salt, or barium salt; beryllium salt; magnesium salt; or the like can be used as the solute of the electrolyte 169 as appropriate.

As a solvent of the electrolyte 169, a material in which lithium ions can move. As the solvent of the electrolyte 169, an aprotic organic solvent is preferably used.

Typical examples of aprotic organic solvents include ethylene carbonate, propylene carbonate, dimethyl carbonate, diethyl carbonate, γ-butyrolactone, acetonitrile, dimethoxyethane, tetrahydrofuran, and the like, and one or more of them can be used. When a gelled polymer material is used as the solvent of the electrolyte 169, safety against liquid leakage or the like is increased. In addition, the energy storage device 151 can be thin and lightweight. Typical examples of the gelled polymer material include a silicon gel, an acrylic gel, an acrylonitrile gel, polyethylene oxide, polypropylene oxide, and a fluorine-based polymer.

As the electrolyte 169, a solid electrolyte such as Li₃PO₄ can be used.

For the separator 167, an insulating porous material is used. Typical examples of the separator 167 include cellulose (paper), polyethylene, and polypropylene.

A lithium ion battery has a small memory effect, a high energy density, and a high discharge capacity. In addition, the driving voltage of the lithium ion battery is high. For those reasons, the size and weight of the lithium ion battery can be reduced. Further, the lithium ion battery is not easily degraded due to repetitive charge and discharge and can be used for a long time, and therefore allows cost reduction.

Second, a capacitor will be described below as another example of the energy storage device. Typical examples of the capacitor include a double-layer capacitor, a lithium ion capacitor, and the like.

In the case of a capacitor, instead of the positive electrode active material layer 177 in the secondary battery in FIG. 3A, a material capable of reversibly absorbing lithium ions and/or anions may be used. Typical examples of the material include active carbon, a conductive polymer, and a polyacene organic semiconductor (PAS).

The lithium ion capacitor has high efficiency of charge and discharge, capability of rapid charge and discharge, and a long life to withstand repeated use.

With the use of the negative electrode described in Embodiment 1 as the negative electrode 163, an energy storage device with a high discharge capacity and less degradation of an electrode due to repetitive charge and discharge can be manufactured. With the use of the negative electrode described in Embodiment 2 as the negative electrode 163, an energy storage device with a high discharge capacity and less degradation of an electrode due to repetitive charge and discharge can be manufactured.

Further, when the current collector and the active material layer which are described in Embodiment 1 are used in a negative electrode of an air cell which is another embodiment of the energy storage device, an energy storage device with a high discharge capacity and less degradation of an electrode due to repetitive charge and discharge can be manufactured. When the current collector and the active material layer which are described in Embodiment 2 are used in a negative electrode of an air cell which is another embodiment of the energy storage device, an energy storage device with a high discharge capacity and less degradation of an electrode due to repetitive charge and discharge can be manufactured.

### EMBODIMENT 4

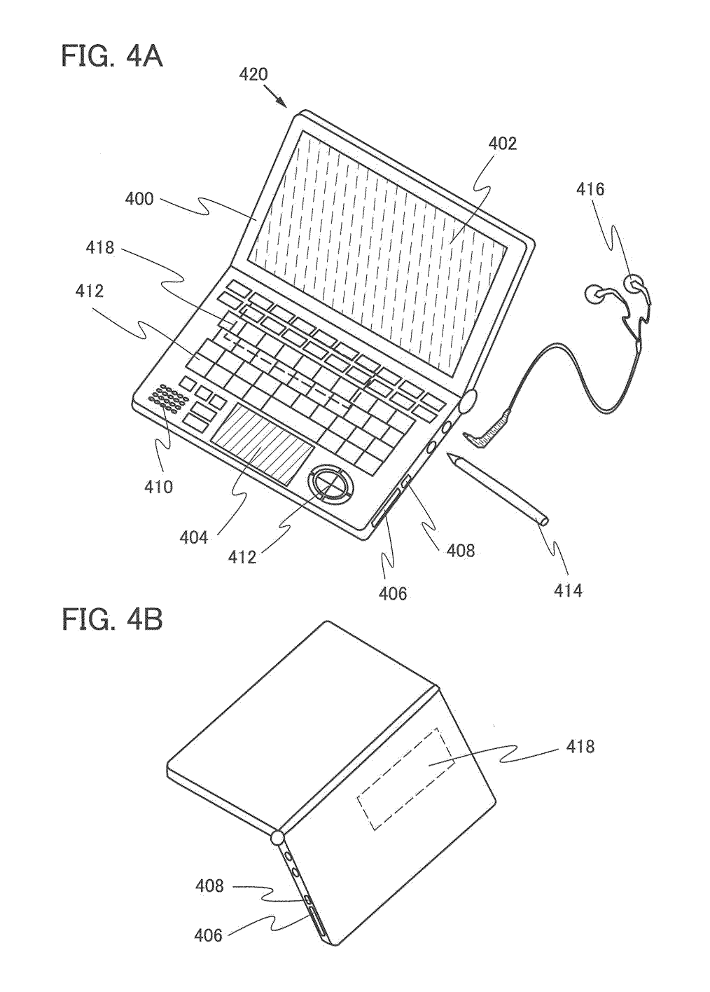

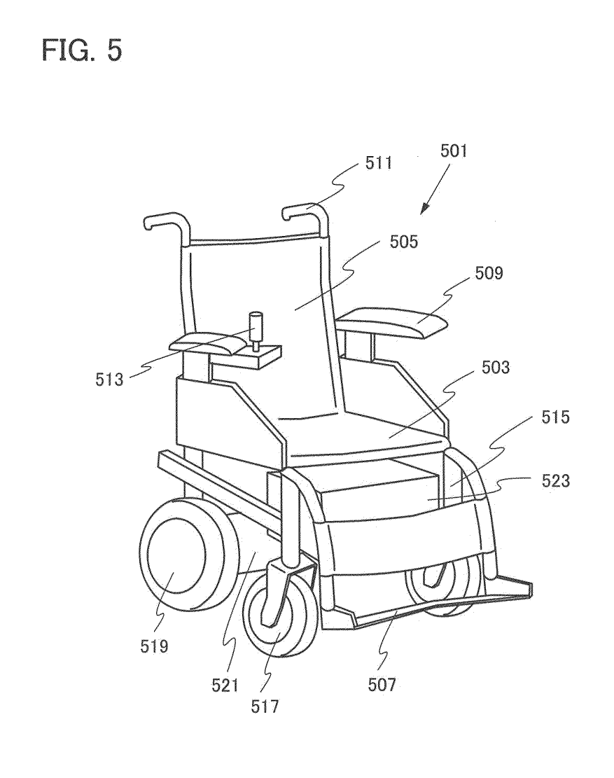

In this embodiment, application examples of the energy storage device described in Embodiment 3 will be described with reference to FIGS. 4A and 4B and FIG. 5.

The energy storage device described in Embodiment 3 can be used in electronic devices such as cameras such as digital cameras or video cameras, digital photo frames, mobile phones (also referred to as cellular phones or cellular phone devices), portable game machines, portable information terminals, and audio players. Further, the energy storage device can be used in electric propulsion vehicles such as electric vehicles, hybrid electric vehicles, train vehicles, maintenance vehicles, carts, or wheelchairs. Here, an electronic dictionary is described as a typical example of the portable information terminals, and a wheelchair is described as a typical example of the electric propulsion vehicles.

FIGS. 4A and 4B are perspective views of an electronic dictionary. Note that FIG. 4B illustrates the back side of the electronic dictionary illustrated in FIG. 4A.

A main body 420 of the electronic dictionary includes a housing 400, a display portion 402, a display portion 404, a recording medium insert portion 406, and an external connection terminal portion 408, a speaker 410, operation keys 412, and a battery mounting portion 418. In addition, the main body 420 may be provided with a terminal portion for attaching earphones 416, a storage portion for carrying a stylus 414 with the main body 420, and the like.

A rechargeable battery (or battery pack) is mounted in the battery mounting portion 418 of the main body 420 as a power source of the electronic dictionary. The battery can be repeatedly used by being charged and is not disposable unlike a dry cell, and thus is economical.

The battery can be charged with the battery incorporated in the main body 420. In that case, a connector for connection to an external power supply device may be inserted into the external connection terminal portion 408 so that the battery can be charged by the external power supply device through the external connection terminal portion 408. Alternatively, the battery may be taken out of the main body 420 and connected to a charger so that the battery can be charged.

The remaining battery level may be displayed on the display portion 402 or the display portion 404. Alternatively, the main body 420 may be provided with a light which is turned on or off in accordance with the remaining battery level. Users check the remaining battery level and determine the timing to charge the battery.

The energy storage device described in Embodiment 3 can be used for the battery (or the battery pack).

FIG. 5 is a perspective view of an electric wheelchair 501.

The electric wheelchair 501 includes a seat 503 where a user sits down, a backrest 505 provided behind the seat 503, a footrest 507 provided at the front of and below the seat 503, armrests 509 provided on the left and right of the seat 503, and a handle 511 provided above and behind the backrest 505.

A controller 513 for controlling the operation of the wheelchair 501 is provided for one of the armrests 509. The wheelchair 501 is provided with a pair of front wheels 517 at the front of and below the seat 503 and a pair of rear wheels 519 behind and below the seat 503 with the use of a frame 515 below the seat 503. The rear wheels 519 are connected to a driver portion 521 having a motor, a brake, a gear, and the like. A control portion 523 including a battery, a power controller, a control means, and the like is provided under the seat 503. The control portion 523 is connected to the controller 513 and the driver portion 521. When the user operates the controller 513, the driver portion 521 is driven through the control portion 523; thus, the operation of moving forward, moving back, turning around, and the like, and the speed of the electric wheelchair 501 are controlled.

The energy storage device described in Embodiment 3 can be used in the battery of the control portion 523.

The battery of the control portion 523 can be externally charged by electric power supply using a plug-in system or contactless power feeding.

Note that in the case where the electric propulsion vehicle is a train vehicle, the battery can be charged by electric power supply from an overhead cable or a conductor rail.

### EMBODIMENT 5

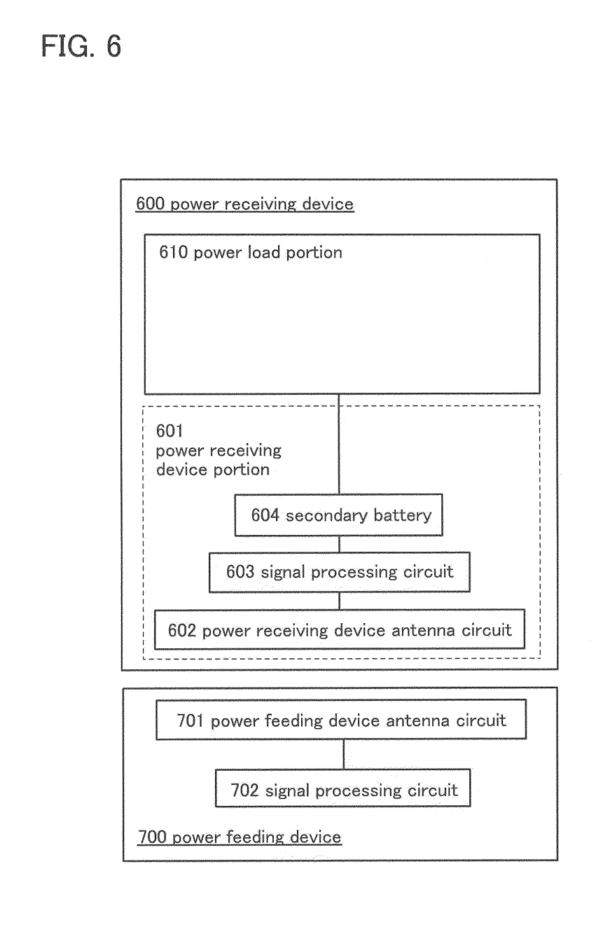

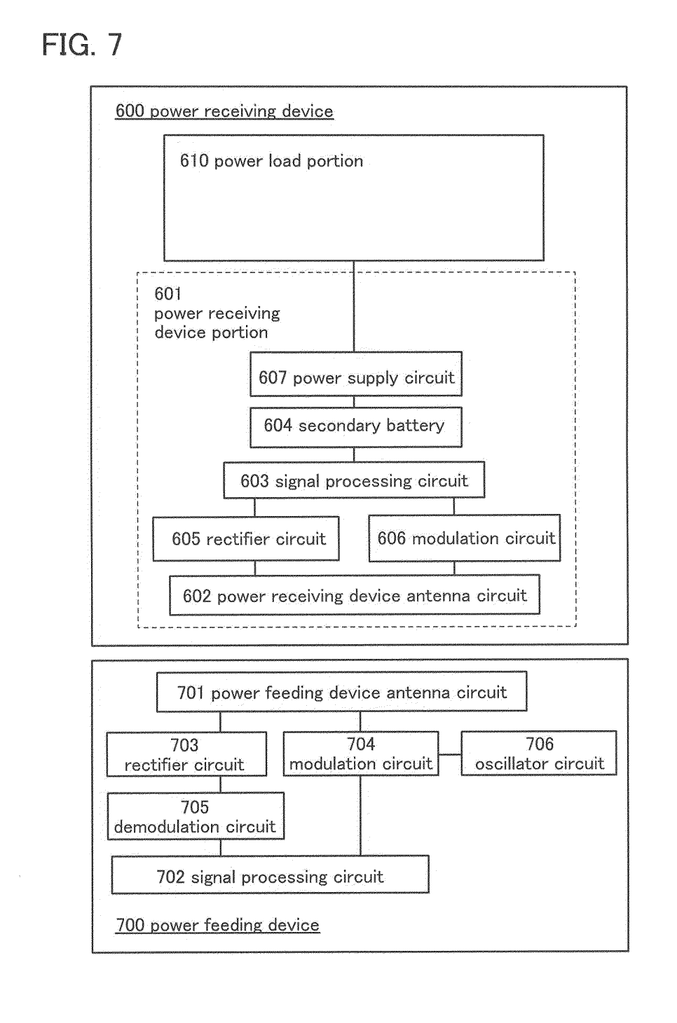

In this embodiment, an example in which a secondary battery which is an example of the energy storage device according to one embodiment of the present invention is used in a wireless power feeding system (hereinafter, also referred to as an RF power feeding system) will be described with reference to block diagrams of FIG. 6 and FIG. 7. In the block diagrams, elements in a power receiving device and a power feeding device are classified according to their functions and included in different blocks. However, it may be practically difficult to completely classify the elements according to their functions; one element may involve a plurality of functions.

First, an example of the RF power feeding system will be described with reference to FIG. 6.

A power receiving device 600 is used in an electronic device or an electric propulsion vehicle which is driven by electric power supplied from a power feeding device 700. The power receiving device 600 can be used as appropriate in another device which is driven by electric power. Typical examples of the electronic device include cameras such as digital cameras or video cameras, digital photo frames, mobile phones (also referred to as cellular phones or cellular phone devices), portable game machines, portable information terminals, audio players, display devices, computers, and the like. Typical examples of the electric propulsion vehicles include electric vehicles, hybrid vehicles, electric train vehicles, maintenance vehicles, carts, wheelchairs, and the like. The power feeding device 700 has a function of supplying electric power to the power receiving device 600.

In FIG. 6, the power receiving device 600 includes a power receiving device portion 601 and a power load portion 610. The power receiving device portion 601 includes at least a power receiving device antenna circuit 602, a signal processing circuit 603, and a secondary battery 604. The power feeding device 700 includes at least a power feeding device antenna circuit 701 and a signal processing circuit 702.

The power receiving device antenna circuit 602 has a function of receiving a signal transmitted by the power feeding device antenna circuit 701 or transmitting a signal to the power feeding device antenna circuit 701. The signal processing circuit 603 has a function of processing a signal received by the power receiving device antenna circuit 602 and controlling charge of the secondary battery 604 and supply of electric power from the secondary battery 604 to the power load portion 610. In addition, the signal processing circuit 603 has a function of controlling the operation of the power receiving device antenna circuit 602. Thus, the intensity, frequency, or the like of a signal transmitted by the power receiving device antenna circuit 602 can be control led.

The power load portion 610 is a driver portion which receives electric power from the secondary battery 604 and drives the power receiving device 600. Typical examples of the power load portion 610 include a motor, a driver circuit, and the like. Another device which receives electric power and drives the power receiving device 600 can be used as the power load portion 610 as appropriate.

The power feeding device antenna circuit 701 has a function of transmitting a signal to the power receiving device antenna circuit 602 or receiving a signal from the power receiving device antenna circuit 602. The signal processing circuit 702 has a function of processing a signal received by the power feeding device antenna circuit 701. In addition, the signal processing circuit 702 has a function of controlling the operation of power feeding device antenna circuit 701. Thus, the intensity, frequency, or the like of a signal transmitted by the power feeding device antenna circuit 701 can be controlled.

The secondary battery according to one embodiment of the present invention is used as the secondary battery 604 included in the power receiving device 600 in the RF power feeding system illustrated in FIG. 6.

With the use of the secondary battery according to one embodiment of the present invention in the RF power feeding system, the amount of energy storage can be larger than that in a conventional secondary battery. Therefore, the time interval of the wireless power feeding can be longer, whereby power feeding can be less frequent.

In addition, with the use of the secondary battery according to one embodiment of the present invention in the RF power feeding system, the size and weight of the power receiving device 600 can be reduced in the case where the secondary battery has the same amount of energy storage for driving the power load portion 610 as a conventional one. Therefore, the total cost can be reduced.

Next, another example of the RF power feeding system will be described with reference to FIG. 7.

In FIG. 7, the power receiving device 600 includes the power receiving device portion 601 and the power load portion 610. The power receiving device portion 601 includes at least the power receiving device antenna circuit 602, the signal processing circuit 603, the secondary battery 604, a rectifier circuit 605, a modulation circuit 606, and a power supply circuit 607. In addition, the power feeding device 700 includes at least the power feeding device antenna circuit 701, the signal processing circuit 702, a rectifier circuit 703, a modulation circuit 704, a demodulation circuit 705, and an oscillator circuit 706.

The power receiving device antenna circuit 602 has a function of receiving a signal transmitted by the power feeding device antenna circuit 701 or transmitting a signal to the power feeding device antenna circuit 701. When the power receiving device antenna circuit 602 receives a signal transmitted by the power feeding device antenna circuit 701, the rectifier circuit 605 has a function of generating a DC voltage from the signal received by the power receiving device antenna circuit 602. The signal processing circuit 603 has a function of processing a signal received by the power receiving device antenna circuit 602, and controlling charge of the secondary battery 604 and supply of electric power from the secondary battery 604 to the power supply circuit 607. The power supply circuit 607 has a function of converting voltage stored in the secondary battery 604 into voltage needed for the power load portion 610. The modulation circuit 606 is used when the power receiving device 600 transmits a signal (or sends a response) to the power feeding device 700.

With the power supply circuit 607, electric power supplied to the power load portion 610 can be controlled. Thus, overvoltage application to the power load portion 610 can be suppressed, and degradation or breakdown of the power receiving device 600 can be prevented.

In addition, with the modulation circuit 606, a signal can be transmitted from the power receiving device 600 to the power feeding device 700. Therefore, when the amount of charged power in the power receiving device 600 is judged to exceed a certain amount, a signal is transmitted from the power receiving device 600 to the power feeding device 700 so that power feeding from the power feeding device 700 to the power receiving device 600 can be stopped. As a result, the secondary battery 604 is not fully charged, which increases the number of times the secondary battery 604 can be charged.

The power feeding device antenna circuit 701 has a function of transmitting a signal to the power receiving device antenna circuit 602 or receiving a signal from the power receiving device antenna circuit 602. When a signal is transmitted to the power receiving device antenna circuit 602, the signal processing circuit 702 has a function of generating a signal which is transmitted to the power receiving device 600. The oscillator circuit 706 has a function of generating a signal with a constant frequency. The modulation circuit 704 has a function of applying voltage to the power feeding device antenna circuit 701 according to the signal generated by the signal processing circuit 702 and the signal with a constant frequency generated by the oscillator circuit 706. Thus, a signal is output from the power feeding device antenna circuit 701. On the other hand, when a signal is received from the power receiving device antenna circuit 602, the rectifier circuit 703 has a function of rectifying the received signal. The demodulation circuit 705 has a function of extracting a signal which is transmitted from the power receiving device 600 to the power feeding device 700, from the signal rectified by the rectifier circuit 703. The signal processing circuit 702 has a function of analyzing the signal extracted by the demodulation circuit 705.

Note that another circuit may be provided between circuits as long as the RF power feeding can be performed. For example, after the power receiving device 600 receives a signal and the rectifier circuit 605 generates DC voltage, a circuit such as a DC-DC converter or regulator which is provided in a subsequent stage may generate constant voltage. Thus, overvoltage application to an inner portion of the power receiving device 600 can be suppressed.

The secondary battery according to one embodiment of the present invention is used as the secondary battery 604 included in the power receiving device 600 in the RF power feeding system illustrated in FIG. 7.

With the use of the secondary battery according to one embodiment of the present invention in the RF power feeding system, the amount of energy storage can be larger than that in a conventional secondary battery. Therefore, the time interval of the wireless power feeding can be longer, whereby power feeding can be less frequent.

In addition, with the use of the secondary battery according to one embodiment of the present invention in the RF power feeding system, the size and weight of the power receiving device 600 can be reduced in the case where the secondary battery has the same amount of energy storage for driving the power load portion 610 as a conventional one. Therefore, the total cost can be reduced.

Note that when the secondary battery according to one embodiment of the present invention is used in the RF power feeding system and the power receiving device antenna circuit 602 and the secondary battery 604 are overlapped with each other, it is preferable that the impedance of the power receiving device antenna circuit 602 is not changed by deformation of the secondary battery 604 due to charge and discharge of the secondary battery 604 and accompanying deformation of the antenna. That is because when the impedance of the antenna is changed, in some cases, electric power is not supplied sufficiently. In order to prevent this problem, for example, the secondary battery 604 may be placed in a battery pack formed using metal or ceramics. Note that in that case, the power receiving device antenna circuit 602 and the battery pack are preferably separated from each other by several tens of micrometers or more.

In this embodiment, the signal for charging has no limitation on its frequency and may have any band of frequency as long as electric power can be transmitted. For example, the signal for charging may have any of an LF band at 135 kHz (long wave), an HF band at 13.56 MHz, a UHF band at 900 MHz to 1 GHz, and a microwave band at 2.45 GHz.

A signal transmission method may be selected as appropriate from a variety of methods including an electromagnetic coupling method, an electromagnetic induction method, a resonance method, and a microwave method. In order to prevent energy loss due to foreign substances containing moisture, such as rain and mud, an electromagnetic induction method or a resonance method using a low frequency band, specifically, frequencies of a short wave of 3 MHz to 30 MHz, a medium wave of 300 kHz to 3 MHz, a long wave of 30 kHz to 300 kHz, or a very-long wave of3 kHz to 30 kHz, is preferably used.

This embodiment can be implemented in combination with any of the above embodiments.

### EXAMPLE 1

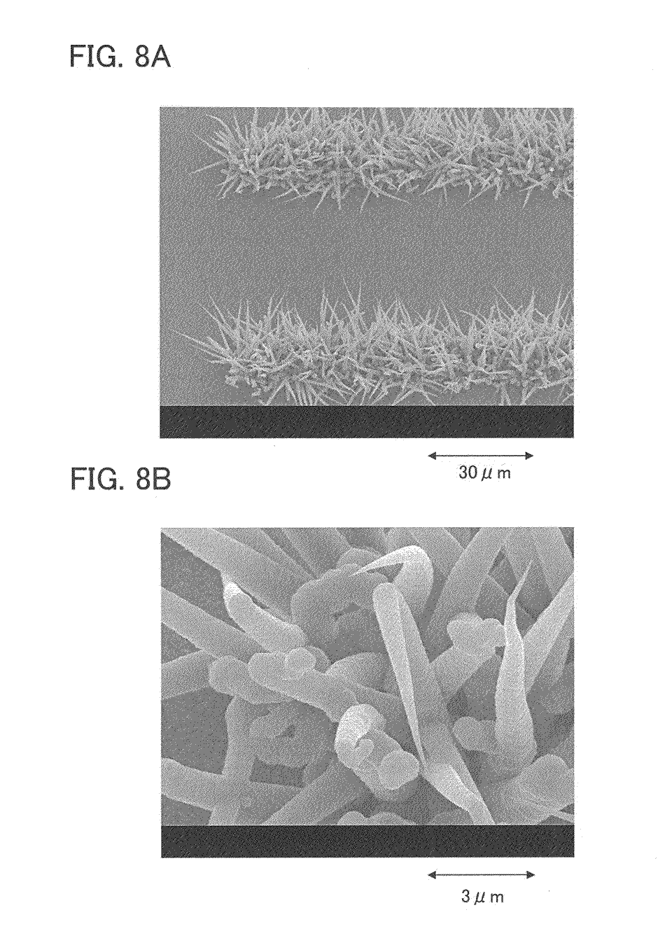

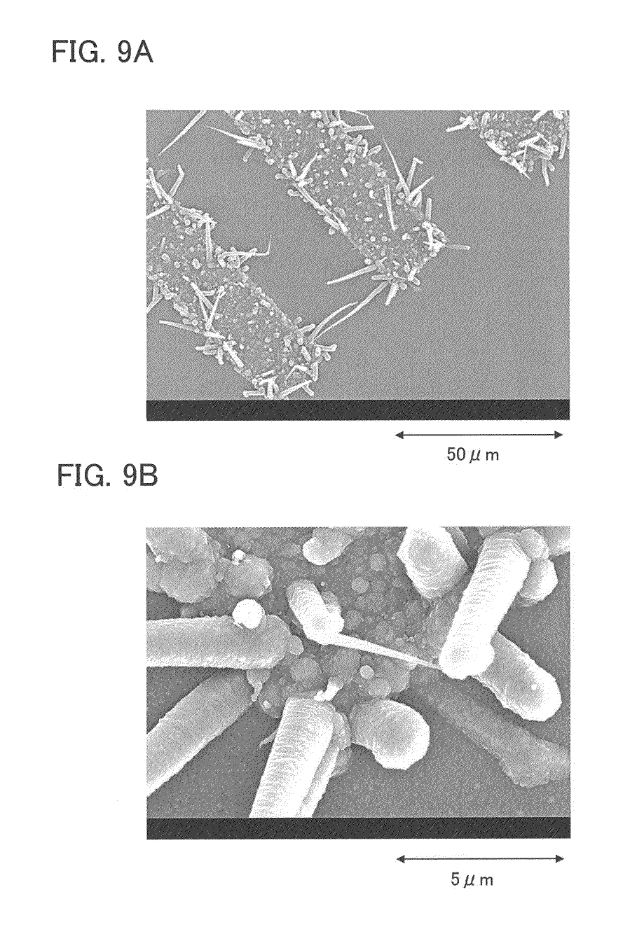

In this example, the shape of a group of whiskers in the case where a crystalline silicon layer is formed using a gas containing silicon as a source gas by an LPCVD method will be described with reference to FIGS. 8A and 8B and FIGS. 9A and 9B.

### <Manufacturing Process of Crystalline Silicon Layer>

First, a manufacturing process of a crystalline silicon layer that is one embodiment of the present invention will be described. When the crystalline silicon layer was formed using a gas containing silicon as a source gas by an LPCVD method, nitrogen was mixed as a dilution gas.

A titanium film with a thickness of 500 nm was formed over a glass substrate by a sputtering method. Then, the titanium film was selectively etched by photolithography to form an island-shaped titanium film, so that a current collector of an electrode was formed.

A crystalline silicon layer was formed as an active material layer over the island-shaped titanium film that was the current collector by an LPCVD method by mixing nitrogen with the gas containing silicon.

Silane (SiH₄) was used as the gas containing silicon. The crystalline silicon layer was formed in such a manner that silane and nitrogen were introduced into a reaction chamber at flow rates of 300 sccm and the pressure and temperature in the reaction chamber were set to 20 Pa and at 600° C., respectively. The deposition time was 2 hours and 15 minutes.

FIGS. 8A and 8B are scanning electron microscope (SEM) images of the formed crystalline silicon layer that is one embodiment of the present invention. The image of FIG. 8A was taken at 1000-fold magnification, and the image of FIG. 8B was taken at 10000-fold magnification.

As shown in FIGS. 8A and 8B, the diameter of a portion with the largest diameter (i.e., a root portion) of a protrusion included in the crystalline silicon layer that is one embodiment of the present invention is about 1.1 μm or less, and most protrusions are sharp. In addition, it was confirmed that a plurality of whiskers was tightly formed so that a group of whiskers was formed. A long whisker has a length of approximately 19 μm along its axis. Note that according to FIG. 8B, the number of whiskers is around 30 per 100 μm².

### <Manufacturing Process of Crystalline Silicon Layer for Comparison>

Next, a manufacturing process of a crystalline silicon layer for comparison will be described. The difference between the crystalline silicon layer for comparison and the crystalline silicon layer that is one embodiment of the present invention is an atmosphere gas in formation by an LPCVD method: nitrogen is not contained in an atmosphere gas in forming the crystalline silicon layer for comparison. The other structures of the crystalline silicon layer for comparison are the same as those of the crystalline silicon layer that is one embodiment of the present invention; therefore, description of the structure of a current collector is omitted.

A crystalline silicon layer was formed as an active material layer over an island-shaped titanium film that is a current collector by an LPCVD method using a gas containing silicon as a source gas.

Silane (SiH₄) was used as the gas containing silicon. The crystalline silicon layer was formed in such a manner that silane was introduced into a reaction chamber at a flow rate of 300 sccm and the pressure and temperature in the reaction chamber were set to 20 Pa and at 600° C., respectively. The deposition time was 2 hours and 15 minutes.

FIGS. 9A and 9B are SEM images of the formed crystalline silicon layer for comparison. The image of FIG. 9A was taken at 1000-fold magnification, and the image of FIG. 9B was taken at 10000-fold magnification.

As shown in FIGS. 9A and 9B, the diameter of a portion with the largest diameter (i.e., a root portion) of a protrusion included in the crystalline silicon layer for comparison is about 1.5 μm or less, and the crystalline silicon layer for comparison includes a larger number of protrusions with rounded ends than the crystalline silicon layer that is one embodiment of the present invention. In addition, it was confirmed that the total number of whiskers in the crystalline silicon layer for comparison and the length of the whisker therein along its axis were smaller and shorter than those in the crystalline silicon layer that is one embodiment of the present invention.

According to FIGS. 8A and 8B and FIGS. 9A and 9B, the crystalline silicon layer that is one embodiment of the present invention has a larger number of long and thin whiskers than the crystalline silicon layer for comparison.

Moreover, a large number of protrusions which had a smaller diameter and which were sharper, longer, and thinner than the protrusion included in the crystalline silicon layer for comparison were observed in the crystalline silicon layer that is one embodiment of the present invention.

Furthermore, it was confirmed that the plurality of whiskers included in the group of whiskers in the crystalline silicon layer that is one embodiment of the present invention was formed more tightly than that in the crystalline silicon layer for comparison.

The above results show that mixing nitrogen as a dilution gas with a gas containing silicon which is used as a source gas in forming the crystalline silicon layer by an LPCVD method allows a group of whiskers in which a plurality of whiskers is tightly formed to be formed in the crystalline silicon layer.

### EXAMPLE 2

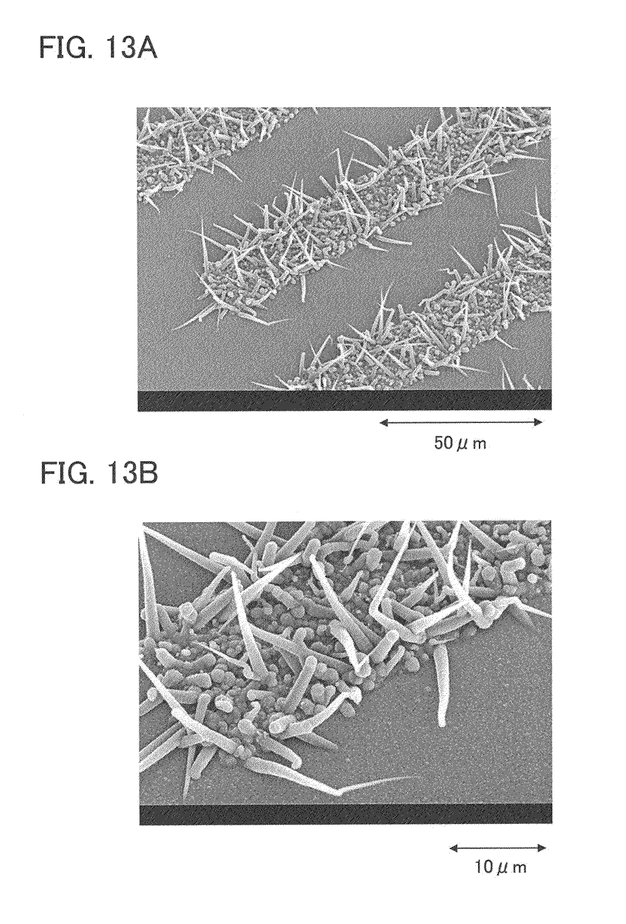

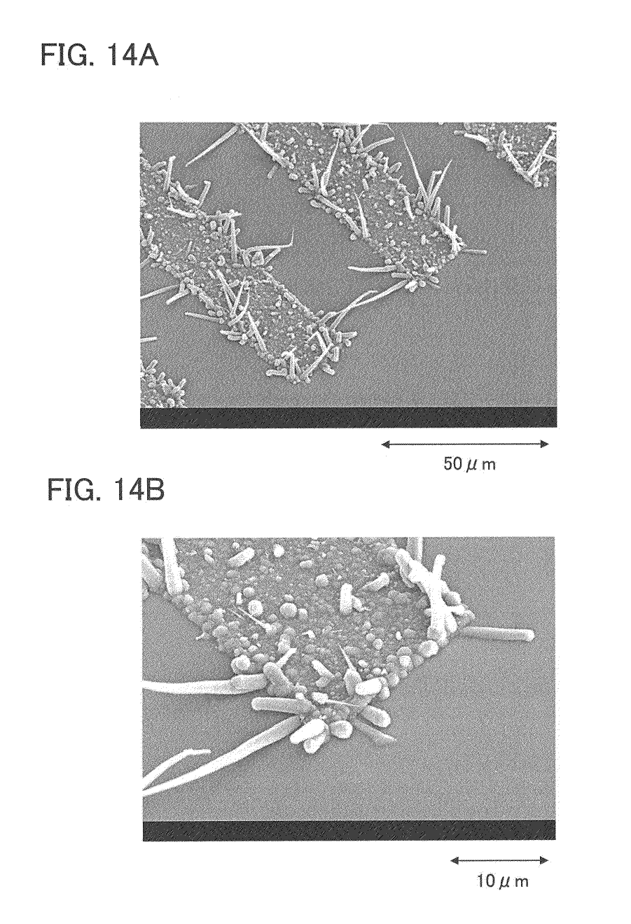

In this example, the shape of a group of whiskers in the case where a crystalline silicon layer is formed using a gas containing silicon as a source gas by an LPCVD method will be described with reference to FIGS. 13A and 13B and FIGS. 14A and 14B.

### <Manufacturing Process of Crystalline Silicon Layer>

First, a manufacturing process of a crystalline silicon layer that is one embodiment of the present invention will be described. When the crystalline silicon layer was formed using a gas containing silicon as a source gas by an LPCVD method, helium was mixed as a dilution gas.

A titanium film with a thickness of 500 nm was formed over a glass substrate by a sputtering method. Then, the titanium film was selectively etched by photolithography to form an island-shaped titanium film, so that a current collector of an electrode was formed.

A crystalline silicon layer was formed as an active material layer over the island-shaped titanium film that was the current collector by an LPCVD method by mixing helium with the gas containing silicon.

Silane (SiH₄) was used as the gas containing silicon. The crystalline silicon layer was formed in such a manner that silane and helium were introduced into a reaction chamber at flow rates of 300 sccm and the pressure and temperature in the reaction chamber were set to 20 Pa and at 600° C., respectively. The deposition time was 2 hours and 15 minutes.

FIGS. 13A and 13B are SEM images of the formed crystalline silicon layer that is one embodiment of the present invention. The image of FIG. 13A was taken at 1000-fold magnification, and the image of FIG. 13B was taken at 3000-fold magnification.

As shown in FIGS. 13A and 13B, the diameter of a portion with the largest diameter (i.e., a root portion) of a protrusion included in the crystalline silicon layer that is one embodiment of the present invention is about 1.4 μm or less. In addition, it was confirmed that a plurality of whiskers was tightly formed so that a group of whiskers was formed. A long whisker has a length of approximately 19 μm along its axis. Note that according to FIG. 13B, the number of protrusions is around 40 per 100 μm².

### <Manufacturing Process of Crystalline Silicon Layer for Comparison>

A crystalline silicon layer for comparison was formed by a method similar to that of the crystalline silicon layer for comparison which is described in Example 1.

FIGS. 14A and 14B are SEM images of the formed crystalline silicon layer for comparison. The image of FIG. 14A was taken at 1000-fold magnification, and the image of FIG. 14B was taken at 3000-fold magnification.

As shown in FIGS. 14A and 14B, the diameter of a portion with the largest diameter (i.e., a root portion) of a protrusion included in the crystalline silicon layer for comparison is about 1.5 μm or less. In addition, it was confirmed that the total number of whiskers in the crystalline silicon layer for comparison and the length of the whisker therein along its axis were smaller and shorter than those in the crystalline silicon layer that is one embodiment of the present invention.

According to FIGS. 13A and 13B and FIGS. 14A and 14B, the crystalline silicon layer that is one embodiment of the present invention has a larger number of long and thin whiskers than the crystalline silicon layer for comparison.

Moreover, a large number of protrusions which were sharper, longer, and thinner than the protrusion included in the crystalline silicon layer for comparison were observed in the crystalline silicon layer that is one embodiment of the present invention.

Furthermore, it was confirmed that the plurality of whiskers included in the group of whiskers in the crystalline silicon layer that is one embodiment of the present invention was formed more tightly than that in the crystalline silicon layer for comparison.

The above results show that mixing helium as a dilution gas with a gas containing silicon which is used as a source gas in forming the crystalline silicon layer by an LPCVD method allows formation of a group of whiskers including a plurality of tightly formed whiskers in the crystalline silicon layer.

This application is based on Japanese Patent Application Ser. No. 2010-149175 filed with the Japan Patent Office on Jun. 30, 2010, and Japanese Patent Application Ser. No. 2010-149164 filed with the Japan Patent Office on Jun. 30, 2010, the entire contents of which are hereby incorporated by reference.

What is claimed is:

1. A manufacturing method of an energy storage device, comprising:
forming a crystalline silicon layer including a group of whiskers over a current collector by a low pressure chemical vapor deposition method using nitrogen and a gas containing silicon.

2. The manufacturing method of an energy storage device according to claim 1,
wherein a flow rate of the gas containing silicon is greater than or equal to 100 sccm and less than or equal to 3000 sccm, and
wherein a flow rate of the nitrogen is greater than or equal to 100 sccm and less than or equal to 1000 sccm.

3. The manufacturing method of an energy storage device according to claim 1,
wherein the gas containing silicon includes silicon hydride, silicon fluoride, or silicon chloride.

4. The manufacturing method of an energy storage device according to claim 1,
wherein a heating temperature in the low pressure chemical vapor deposition method is higher than or equal to 595° C. and lower than 650° C.

5. The manufacturing method of an energy storage device according to claim 1,
wherein pressure in the low pressure chemical vapor deposition method is greater than or equal to 10 Pa and less than or equal to 100 Pa.

6. The manufacturing method of an energy storage device according to claim 1,
wherein the group of whiskers comprises a plurality of needle-like protrusions.

7. The manufacturing method of an energy storage device according to claim 1,
wherein the current collector is formed by a sputtering method, an evaporation method, a printing method, an ink-jet method, or a chemical vapor deposition method.

8. The manufacturing method of an energy storage device according to claim 1,
wherein titanium is used as the current collector.

9. The manufacturing method of an energy storage device according to claim 1, further comprising the step of providing a positive electrode opposite the crystalline silicon layer.

10. The manufacturing method of an energy storage device according to claim 9,
wherein a separator is provided between the crystalline silicon layer and the positive electrode.

11. The manufacturing method of an energy storage device according to claim 1,
wherein the crystalline silicon layer serves as an active material layer.

12. A manufacturing method of an energy storage device, comprising:
forming a crystalline silicon layer including a group of whiskers over a current collector by a low pressure chemical vapor deposition method using helium and a gas containing silicon.

13. The manufacturing method of an energy storage device according to claim 12,
wherein a flow rate of the gas containing silicon is greater than or equal to 100 sccm and less than or equal to 3000 sccm, and
wherein a flow rate of the helium is greater than or equal to 100 sccm and less than or equal to 1000 sccm.

14. The manufacturing method of an energy storage device according to claim 12,
wherein the gas containing silicon includes silicon hydride, silicon fluoride, or silicon chloride.

15. The manufacturing method of an energy storage device according to claim 12,
wherein a heating temperature in the low pressure chemical vapor deposition method is higher than or equal to 595° C. and lower than 650° C.

16. The manufacturing method of an energy storage device according to claim 12,
wherein pressure in the low pressure chemical vapor deposition method is greater than or equal to 10 Pa and less than or equal to 100 Pa.

17. The manufacturing method of an energy storage device according to claim 12,
wherein the group of whiskers comprises a plurality of needle-like protrusions.

18. The manufacturing method of an energy storage device according to claim 12,
wherein the current collector is formed by a sputtering method, an evaporation method, a printing method, an ink-jet method, or a chemical vapor deposition method.

19. The manufacturing method of an energy storage device according to claim 12,
wherein titanium is used as the current collector.

20. The manufacturing method of an energy storage device according to claim 12, further comprising the step of providing a positive electrode opposite the crystalline silicon layer.

21. The manufacturing method of an energy storage device according to claim 20,
wherein a separator is provided between the crystalline silicon layer and the positive electrode.

22. The manufacturing method of an energy storage device according to claim 12,
wherein the crystalline silicon layer serves as an active material layer.
